(19) United States
(12) Patent Application Publication
(10) Pub. No.: US 2025/0137486 A1
(43) Pub. Date: May 1, 2025

(54) AXIAL ROLLING BEARING UNIT WITH ROLLING BODIES, WHICH ARE ARRANGED BETWEEN ANNULAR AXIAL BEARING WASHERS, IN THE FORM OF A SELF-FIXING ASSEMBLY

(71) Applicant: Schaeffler Technologies AG & Co. KG, Herzogenaurach (DE)

(72) Inventors: Wolfgang Fugel, Nürnberg (DE); Andreas Kirschner, Aurachtal (DE); Frank Schoenstein, Baiersdorf (DE)

(73) Assignee: Schaeffler Technologies AG & Co. KG, Herzogenaurach (DE)

(21) Appl. No.: 18/683,268

(22) PCT Filed: Aug. 10, 2022
(86) PCT No.: PCT/DE2022/100582

§ 371 Date: Feb. 13, 2024

(30) Foreign Application Priority Data
Sep. 9, 2021 (DE) 10 2021 123 373.9

(51) Int. Cl. F16C 19/30

(52) U.S. Cl. CPC F16C 19/30

(57) ABSTRACT

An axial rolling bearing unit includes a first annular axial bearing washer, a second annular axial bearing washer, a bearing cage, and rolling elements arranged between the first annular axial bearing washer and the second annular axial bearing washer. The bearing cage includes an inner radial edge rim extending in an axial direction to radially guide the rolling elements, and an outer radial edge rim extending in the axial direction to radially guide the rolling elements. The inner radial edge rim or the outer radial edge rim includes an end-side bend extending in an opposite axial direction as a double-rim design, and the end-side bend has a first distal end section that holds the first annular axial bearing washer in a form-fitting manner. The other one of the inner radial edge rim or the outer radial edge rim holds the second annular axial bearing washer in a form-fitting manner.

### CROSS-REFERENCE TO RELATED APPLICATIONS

This application is the United States National Phase of PCT Appln. No. PCT/DE22/100582 filed Aug. 5 10, 2022, which claims priority to German Application No. DE102021123373.9 filed Sep. 9, 2021, the entire disclosures of which are incorporated by reference herein.

### TECHNICAL FIELD

The present disclosure relates to a rolling bearing unit with rolling elements which are arranged between two annular axial bearing washers and which are guided by means of a bearing cage formed from a sheet metal material. The field of application of the present invention extends primarily to automotive applications in which, for example, a shaft provided with helically toothed gears is subjected to an axial force which is to be absorbed by a suitable axial bearing relative to a transmission housing or the like.

### BACKGROUND

DE 103 13 183 A1 shows an axial rolling bearing unit of the type of interest here. In this disclosure, a collar is arranged on an outer peripheral edge of an axial bearing washer, which is extended by a flange. In a region composed of the collar and flange, a radially inwardly directed nose-like projection is formed, which engages radially behind the cage on the outer circumference. The other axial bearing washer is designed as an angled washer and engages behind the bearing cage on the inner circumference with an axial leg. This angular geometry of the axial bearing washers creates a self-retaining axial rolling bearing unit.

When mounting the bearing cage in the axial bearing washers, which are designed as angled washers, an unfavorable concentricity between the bearing cage and the axial bearing washer can occur, particularly in automated manufacturing. This can result in either bending of the bearing cage or shearing of the retaining lugs on the axial bearing washers. If not detected, this leads to a disturbed running behavior of the axial bearing and can even lead to failure of the entire bearing point. If the overlap between the axial bearing washer, which is designed as an angled washer, and the bearing cage is too small, the axial rolling bearing unit may even be dismantled as a result of vibration stress.

Such axial rolling bearing units usually have a high radial clearance between the bearing cage and the axial bearing washers due to the application, which can lead to a quite significant noise development during operation.

### SUMMARY

The present disclosure includes the technical teaching that, in an axial rolling bearing unit with rolling elements which are arranged between two annular axial bearing washers and which are guided by means of a bearing cage formed from a sheet metal material, said bearing cage has an inner and outer radial edge rim extending in the axial direction in order to radially guide the rolling elements. At least one of the edge rims is provided with an end-side bend in the opposite direction, thus having a double-rim design, and the distal end section thereof is designed to hold the first axial bearing washer in a form-fitting manner. An edge rim of the bearing cage lying opposite the double rim is designed to hold the second axial bearing washer in a form-fitting manner, in order to create an overall self-retaining structural unit.

The disclosed device therefore makes use of a small number of components, which are functionally integrated in a specialized manner. The bearing cage not only serves as a carrier for the rolling elements, but also becomes the decisive guiding element of the axial bearing due to the overall design. Depending on the diameter, this leads to a reduction in the radial guide tolerance to around ⅓ and also to a corresponding reduction in noise. Since, contrasting with the prior art discussed at the outset, the disclosed device uses annular and flat axial bearing washers, corresponding material savings are also achieved. In the case of width adjustments to the axial rolling bearing unit due to larger diameter rolling elements, e.g., rollers or needles, only the bearing cage needs to be adapted in terms of construction, as the axial bearing washers are independent of this.

According to an example embodiment of the axial rolling bearing unit, the edge rim designed as a double rim is arranged radially inwards and the other edge rim radially outwards of the bearing cage. This makes it possible to implement a precise movement clearance in the radial direction of up to 0.1 mm in relation to a shaft or the like carrying the axial rolling bearing unit, as a double rim can be formed more precisely and with greater dimensional stability than a simple angling of a leading axial bearing component.

According to a further embodiment, the other edge rim of the bearing cage is also provided with a distal end section for holding the second axial bearing washer in a form-fitting manner. For this purpose, both distal end sections of the edge rims may have a rim border which at least partially surrounds the associated axial bearing washer.

In order to facilitate bending, these edge rims can be wall-ironed by means of forming technology. This means that end sections of thinner material are produced when the bearing cage is deep-drawn. These may interact with axial bearing washers, each of which has an inner and outer radial edge shoulder, so that the rim border bent over to form the enclosure does not project beyond the outer side surface of the axial bearing washers.

Alternatively, it is proposed that the axial bearing washers each have an inner and outer radial edge bevel which interacts with the respectively associated distal end section of the edge rim in such a way that the bent-over rim border comes to bear at least partially against it. Compared to the above embodiment, this requires a bend of less than 90°, e.g., 40° to 50°, or around 45°. This can be achieved using forming technology with less risk of cracking at the bending point. Individual caulkings introduced along the circumference are considered otherwise sufficient.

The two axial bearing washers are designed as identical parts and can therefore be used universally. In addition to a reduction in manufacturing costs, the number of individual parts required is, for example, also reduced. Thus, the axial rolling bearing unit according to the disclosure includes three different types of individual components.

The form-fitting manner in which the axial bearing washers are held in accordance with the disclosure forms the prerequisite for implementing a movement gap of, for example, 0.1 to 0.4 mm, e.g., 0.2 to 0.3 mm, between these and the associated distal end section of the respective edge rim. This high-precision guidance also results in a corresponding reduction in noise during operation without adversely affecting the rolling bearing properties.

In addition, a manufacturing advantage of the axial rolling bearing unit according to the disclosure results from the fact that not only the bearing cage is made of a formed sheet metal material, but, for example, also the annular axial bearing washers, which can be produced by means of forming technology as stamped and embossed parts. In particular, the edge bevel or the edge shoulder of the axial bearing washers can be produced in a simple manner by means of embossing.

### BRIEF DESCRIPTION OF THE DRAWINGS

The disclosure is described in more detail below together with the description of exemplary embodiments using the figures. In the figures:

FIG. 1 shows a perspective sectional view of an axial rolling bearing unit according to the disclosure in a first embodiment, and

FIG. 2 shows a perspective sectional view of an axial rolling bearing unit according to the disclosure in a second embodiment.

### DETAILED DESCRIPTION

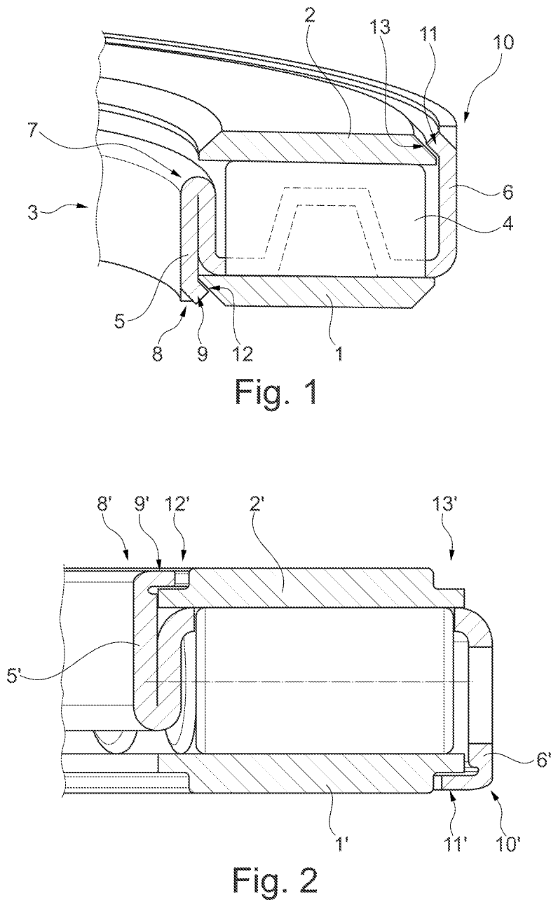

According to FIG. 1, an axial rolling bearing unit includes two identical annular axial bearing washers 1 and 2, between which rolling elements 4 guided by a bearing cage 3 are arranged (by way of example).

The bearing cage 3 is made from a sheet metal material by means of forming technology and has an inner radial edge rim 5 extending in the axial direction and an outer radial edge rim 6 also extending in the axial direction. The rolling elements 4, which are designed as rollers or needles, are guided radially between the two edge rims 5 and 6.

In this exemplary embodiment, the inner radial edge rim 5 is designed as a double rim and is provided with an end-side bend 7 in the opposite direction in this respect. This results in a doubling of the material in terms of sheet thickness. In this regard, the distal end section 8 of the inner radial edge rim 5 serves to hold the first axial bearing washer 1 in a form-fitting manner. The edge rim 6 of the bearing cage 3 lying opposite the double rim is designed to hold the second axial bearing washer 2 in a form-fitting manner, and the distal end section 10 thereof is used here to surround the associated axial bearing washer 2.

Both distal end sections 8 and 10 have an edge rim 9 or 11 which at least partially surrounds the associated axial bearing washer 1 or 2. In this exemplary embodiment, the two edge rims 9 and 11 are formed as caulkings, of which-not further shown here-several caulkings are arranged distributed along the respective circumference in order to enclose the associated axial bearing washers 1 and 2 in a form-fitting manner.

In this exemplary embodiment, the form-fitting enclosure is achieved in such a way that the at least partially bent rim borders 9 and 10 come to bear against the axial bearing washers 1 and 2 by means of edge bevels 12 and 13 that are introduced radially on the inside and outside respectively. The edge bevels are formed here at an angle of 45° to the longitudinal axis of the bearing. A rim border 9 or 11 with a relatively small partial bend is sufficient for this.

According to FIG. 2, in contrast to this, the axial bearing washers 1′ and 2′ each have an inner and outer radial edge shoulder 12′ and 13′, which in principle forms a 90° bend of the edge region. A respectively associated wall-ironed distal end section 8′ and 10′ of the associated edge rims 5′ and 6′, which is therefore of thinner material compared to the edge rim thickness, comes to bear against this in such a way that the enclosure does not project beyond the outer side surface of the axial bearing washer 1′ and 2′. In this exemplary embodiment, in contrast to the exemplary embodiment described above, the entire rim border 9 and 10 should be bent by 90° in each case.

### REFERENCE NUMERALS

1, 1′ Axial bearing washer

2, 2′ Axial bearing washer

3 Bearing cage

4 Rolling elements

5, 5′ First edge rim

6, 6′ Second edge rim

7 Bend

8, 8′ First distal end section

9, 9′ First rim border

10, 10′ Second distal end section

11, 11′ Second rim border

12, 12′ Inner radial edge bevel/shoulder

13, 13′ Outer radial edge bevel/shoulder

1. An axial rolling bearing unit with rolling elements which are arranged between two annular axial bearing washers and which are guided by means of a bearing cage formed from a sheet metal material, said bearing cage having an inner and outer radial edge rim extending in the axial direction in order to radially guide the rolling elements, wherein at least one of the edge rims is provided with an end-side bend in the opposite direction thus having a double-rim design, wherein the distal end section thereof is designed to hold the first axial bearing washer in a form-fitting manner, and an edge rim of the bearing cage lying opposite the double rim is designed to hold the second axial bearing washer in a form-fitting manner, in order to create an overall self-retaining structural unit.

2. The axial rolling bearing unit according to claim 1, wherein the edge rim designed as a double rim is arranged radially inwards and the other edge rim radially outwards of the bearing cage.

3. The axial rolling bearing unit according to claim 1, wherein the other edge rim of the bearing cage is also provided with a distal end section for holding the second axial bearing washer in a form-fitting manner.

4. The axial rolling bearing unit according to claim 3, wherein both distal end sections have a rim border which at least partially surrounds the associated axial bearing washer.

5. The axial rolling bearing unit according to claim 3, wherein the axial bearing washers each have an inner and outer radial edge bevel which interacts with the respectively associated distal end section of the edge rim in such a way that the bent-over rim border comes to bear against it.

6. The axial rolling bearing unit according to claim 3, wherein at least one of the distal end sections of the edge rims is wall-ironed by means of forming technology in order to facilitate bending.

7. The axial rolling bearing unit according to claim 6, wherein the axial bearing washers each have an inner and outer radial edge shoulder which interacts with the respectively associated wall-ironed distal end section of the edge rim in such a way that the rim border bent over to form the enclosure does not project beyond the outer side surface of the axial bearing washers.

8. The axial rolling bearing unit according to claim 1, wherein both axial bearing washers are designed as identical parts.

9. The axial rolling bearing unit according to claim 1, wherein a movement gap of 0.1 to 0.4 millimeters is provided between the axial bearing washer and the distal end section of the associated edge rim.

10. The axial rolling bearing unit according to claim 1, wherein the annular axial bearing washers are also produced by means of forming technology from a sheet metal material as stamped and embossed parts.

11. An axial rolling bearing unit comprising:
a first annular axial bearing washer;
a second annular axial bearing washer;
a bearing cage formed from sheet metal material; and
rolling elements arranged between the first annular axial bearing washer and the second annular axial bearing washer; wherein:
the bearing cage comprises:
an inner radial edge rim extending in an axial direction to radially guide the rolling elements; and
an outer radial edge rim extending in the axial direction to radially guide the rolling elements;
a one of the inner radial edge rim or the outer radial edge rim comprises an end-side bend extending in an opposite axial direction as a double-rim design;
the end-side bend comprises a first distal end section that holds the first annular axial bearing washer in a form-fitting manner; and
the other one of the inner radial edge rim or the outer radial edge rim holds the second annular axial bearing washer in a form-fitting manner.

12. The axial rolling bearing unit of claim 11, wherein the one of the inner radial edge rim or the outer radial edge rim is the inner radial edge rim.

13. The axial rolling bearing unit of claim 11, wherein the other one of the inner radial edge rim or the outer radial edge rim comprises a second distal end section that holds the second annular axial bearing washer in a form-fitting manner.

14. The axial rolling bearing unit of claim 13, wherein:
the first distal end section comprises a first rim border that at least partially surrounds the first annular axial bearing washer; and
the second distal end section comprises a second rim border that at least partially surrounds the second annular axial bearing washer.

15. The axial rolling bearing unit of claim 14, wherein:
the first annular axial bearing washer comprises a first radial edge bevel;
the first rim border bears against the first radial edge bevel;
the second annular axial bearing washer comprises a second radial edge bevel; and
the second rim border bears against the second radial edge bevel.

16. The axial rolling bearing unit of claim 14, wherein:
the first distal end section is wall-ironed by forming technology to facilitate bending; or
the second distal end section is wall-ironed by forming technology to facilitate bending.

17. The axial rolling bearing unit of claim 16, wherein:
the first annular axial bearing washer comprises a first radial edge shoulder;
the first distal end section is arranged in the first radial edge shoulder such that the first rim border does not project beyond a first outer side surface of the first annular axial bearing washer;
the second annular axial bearing washer comprises a second radial edge shoulder; and
the second distal end section is arranged in the second radial edge shoulder such that the second rim border does not project beyond a second outer side surface of the second annular axial bearing washer.

18. The axial rolling bearing unit of claim 11, wherein the first annular axial bearing washer and the second annular axial bearing washer are identical parts.

19. The axial rolling bearing unit of claim 11, further comprising a movement gap of 0.1 to 0.4 millimeters between the first annular axial bearing washer and the first distal end section.

20. The axial rolling bearing unit of claim 11 wherein:
the first annular axial bearing washer is formed from sheet metal by stamping and embossing; and
the second annular axial bearing washer is formed from sheet metal by stamping and embossing.
